(19) United States
(12) Patent Application Publication
(10) Pub. No.: US 2015/0378179 A1
(43) Pub. Date: Dec. 31, 2015

(54) GLASSES HAVING DETACHABLE AUXILIARY LENSES

(71) Applicants: SEONG KYU LIM, (US); MYEONG HEE KIM, (US); JONG HO LIM, (US); JONG YUN LIM, (US)

(72) Inventors: SEONG KYU LIM, Daegu (KR); MYEONG HEE KIM, Daegu (KR); JONG HO LIM, Daegu (KR); JONG YUN LIM, Daegu (KR)

(21) Appl. No.: 14/765,820

(22) PCT Filed: Feb. 5, 2013
(86) PCT No.: PCT/KR2013/000929

§ 371 Date: Aug. 4, 2015

(51) Int. Cl. G02C 9/04

(52) U.S. Cl. CPC G02C 9/04; G02C 2200/02

(57) ABSTRACT

Disclosed herein are glasses having detachable auxiliary lenses. A transparent magnetic film (14) is applied to a front surface of each of main lenses (14) of a main eyeglass body (10). A transparent magnetic film (22) is applied to a rear surface of each of the auxiliary lenses (20), which are detachably attached to the main eyeglass body (10). Therefore, attachment or detachment of the auxiliary lenses (320) to or from the main eyeglass body (10) can be facilitated. In addition, the glasses according to the present invention can be light and provide improved wearing comfort even when the auxiliary lenses are attached to the main lenses.

### TECHNICAL FIELD

The present disclosure relates to glasses, and more particularly, to glasses having detachable auxiliary lenses which have an improved structure such that the auxiliary lenses are comparatively light and can be easily attached to or detached from the glasses.

### BACKGROUND ART

Generally, many people wear glasses for various purposes. For example, glasses may be used for eyesight correction such as presbyopia, ametropia, heterotopias, or eye dysfunction correction, or for protecting the eyes from harmful rays. Furthermore, a weak-sighted person may use glasses with the purpose of visual function training. In addition, glasses may be used for the purpose of beauty, fashion, or leisure or sports such as shooting, climbing, etc.

Recently, as high-tech materials are proposed, the weights of such glasses, which are used for a variety of purposes, are reducing. Furthermore, necessity for a variety of glasses is increasing to meet various personalities of users or provide decorative beauty. Meanwhile, if a person who has worn sight corrective glasses has presbyopia, he/she may have to use separate auxiliary glasses depending on peripheral conditions or a target to see. Here, the auxiliary glasses can be used in such a way that the user puts on the auxiliary glasses or attaches the auxiliary glasses to the corrective glasses. Furthermore, for example, if a person who has worn sight corrective glasses drives a vehicle, he/she may have to wear both the sight corrective glasses and separate sight protective glasses.

With regard to this, there are many conventional techniques or prior patent documents that pertain to auxiliary glasses, which are used in such a way that they are attached to sight corrective glasses.

As representative examples of such prior patent documents, there are Korean Utility Model Registration No. 20-0408813, entitled “AUXILIARY GLASSES HAVING LENSES PROVIDED WITH MAGNETS”, and Korean Utility Model Registration No. 20-0250340, entitled “RIMLESS GLASSES HAVING DETACHABLE AUXILIARY LENSES”.

Although a lot of techniques pertaining to attaching auxiliary lenses to main lenses have been introduced in the conventional techniques including the techniques introduced in the above prior patent documents, auxiliary glasses that are lighter and enable a user to more easily put on or take off them are still required.

### DISCLOSURE

### Technical Problem

Various embodiments are directed to glasses having detachable auxiliary lens which have an improved structure such that the auxiliary lenses are comparatively light and can be easily attached to or detached from the glasses.

### Technical Solution

In view of the above, the present invention provides glasses having detachable auxiliary lenses, wherein a transparent magnetic film (14) is applied to a front surface of each of main lenses (14) of a main eyeglass body (10), and a transparent magnetic film (22) is applied to a rear surface of each of the auxiliary lenses (20) that are detachably attached to the respective main lenses (14).

Each of the transparent magnetic films (14) and (22) of the main lenses (14) and the auxiliary lenses (20) may comprise a cobalt-added titanium dioxide film and is provided along a perimeter of the corresponding lens (14), (20).

An alignment mark (30) may be formed on each of the main lenses (14) and the auxiliary lenses (20) so that alignment of the auxiliary lenses (20) with the respective main lenses (14) is facilitated when the auxiliary lenses (20) are attached to the corresponding main lenses (14).

### Advantageous Effects

In glasses having detachable auxiliary lenses according to the present invention, transparent magnetic films are respectively applied to main lenses of a main eyeglass body and auxiliary lenses, which are attached to the respective main lenses. Therefore, the auxiliary lenses can be more easily attached to or detached from the main lenses. In addition, the glasses according to the present invention are comparatively light and can provide improved wearing comfort even when the auxiliary lenses are attached to the main lenses.

### BRIEF DESCRIPTION OF DRAWINGS

FIG. 1 is a perspective view showing the configuration of glasses having detachable auxiliary lenses according to an embodiment of the present invention,

FIG. 2 is a sectional view showing the configuration of the glasses in which auxiliary lenses are attached to main lenses of a main eyeglass body according to the present invention,

FIG. 3 is an exploded perspective view illustrating attachment of the auxiliary lenses to the main lenses of the main eyeglass body of the glasses using magnetic force according to the present invention, and

FIG. 4 shows perspective views of various types of auxiliary lenses.

### MODE FOR INVENTION

Hereafter, exemplary embodiments of the present invention will be described in detail with reference to the accompanying drawings.

The present invention is embodied such that auxiliary lenses rather than auxiliary glasses are detachably coupled to a main eyeglass body of glasses. The auxiliary lenses are formed of only lenses without having a separate eyeglass frame. Therefore, the auxiliary lenses are comparatively light and portable because they are made of only lenses without use of a separate eyeglass frame.

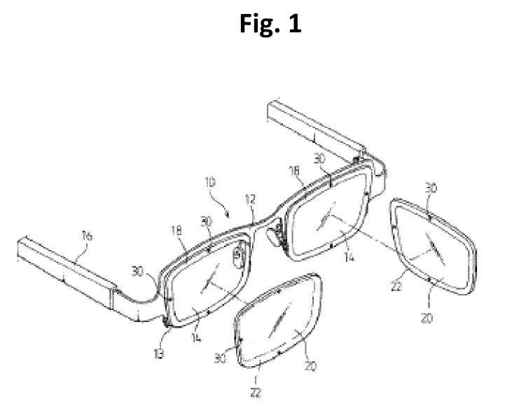

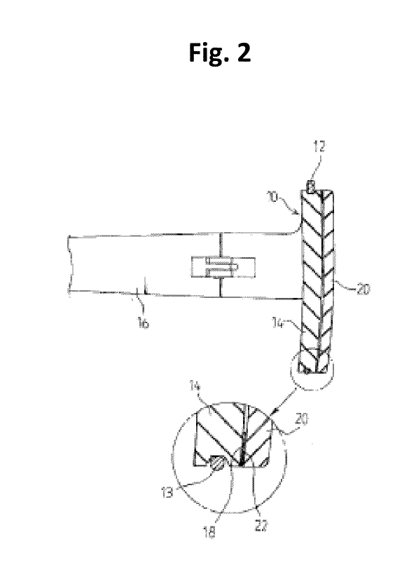

FIG. 1 is a perspective view of glasses having detachable auxiliary lenses according to an embodiment of the present invention. FIG. 2 is a sectional view showing the configuration of the glasses in which auxiliary lenses 20 are attached to main lenses 14 of a main eyeglass body 10 according to the present invention.

The configuration of the glasses having the detachable auxiliary lenses according to the present invention is characterized in that transparent magnetic films 18 and 22 are respectively applied to the main lenses 14 of the main eyeglass body 10 and the auxiliary lenses 20 which are attached to the main lenses 14.

To facilitate attachment of the auxiliary lenses 20 to the main lenses 14 of the main eyeglass body 10, it is preferable that the thickness of the main lenses 14 be similar to that of the glass frame 12 of the main eyeglass body 10 or be set such that the main lenses 14 protrude from a front surface of the eyeglass frame 12; however, even if not, the glasses according to the present invention can be embodied.

For example, as shown in FIG. 1, in the main eyeglass body 10, the eyeglass frame 12 may be made of a high-strength light alloy such as an aluminum alloy to reduce the thickness of the eyeglass frame 12, or as needed, a rimless eyeglass frame or a half-frame eyeglass frame shown in FIG. 1 may be used. In this case, the main eyeglass body 10 is light and facilitates attachment or detachment of the auxiliary lenses 20 to or from the main lenses 14.

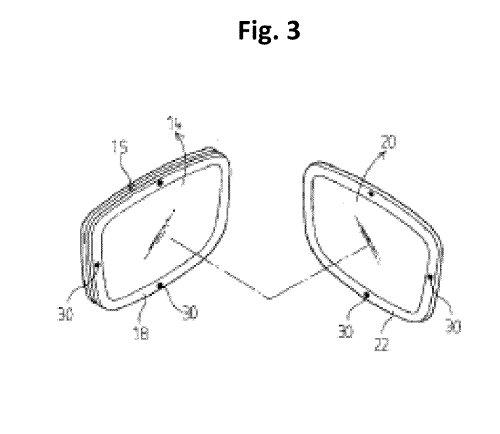

As shown in FIG. 3, a coupling groove 15 is formed around the periphery of each main lens 24 of the main eyeglass body 10 so that the main lens 14 can be fitted into the eyeglass frame 12 that is thin. As shown in FIGS. 1 and 2, the main eyeglass body 10, in which the main lenses 24 protrude forward from the eyeglass frame 12, can be configured in such a way that inward protrusions of the thin eyeglass frame 12 are fitted into the coupling grooves 15 of the main lenses 24.

Particularly, in the present invention, the transparent magnetic films 18 and 22 are respectively applied to the main lenses 14 and the auxiliary lenses 20 so that the auxiliary lenses 20 are attached to the respective main lenses 14 by magnetic force.

Each of the transparent magnetic films 18 and 22 is a cobalt-added titanium dioxide (Co:TiO₂) film in which cobalt atoms having magnetic properties are added to titanium dioxide (TiO₂) by several percentages (%). At not only room temperature but also comparatively high temperature, the transparent magnetic films 18 and 22 can be maintained almost transparent with magnetic properties. Each transparent magnetic film 18, 22 that is made of a cobalt-added titanium dioxide (Co: TiO₂) film is a ferromagnetic body at room temperature.

Preferably, transparent magnetic films 18 and 22 are respectively provided on the perimeters of the main lenses 14 and the auxiliary lenses 20 other than portions of the lenses 14 and 20 corresponding to the focal points of the eyes of a user. The transparent magnetic films 18 are applied to front surfaces of the main lenses 14, and the transparent magnetic films 22 are applied to rear surfaces of the auxiliary lenses 20.

In detail, the transparent magnetic films 18 and 22, which are applied to the front surfaces of the main lenses 14 and the rear surfaces of the auxiliary lenses 20, are preferably provided along the perimeters of the respective lenses 14 and 20. Here, a range, within which each transparent magnetic film 14, 22 is formed on the corresponding lens, must be determined such that even when the lenses 14 and 20 are processed to correspond to the shape of an eyeglass frame selected to a consumer, a sufficient area of each transparent magnetic film 18, 22 can remain on the perimeter of the corresponding lens 14, 20.

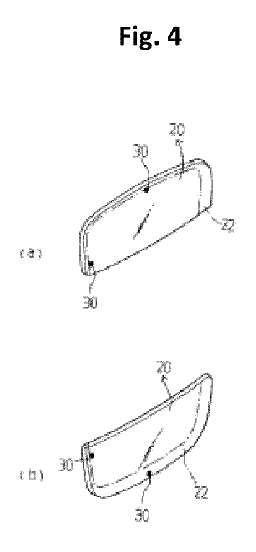

The size of each auxiliary lens 20, which has the transparent magnetic film 22 on the rear surface thereof, may be the same as that of the corresponding main lens 14. Alternatively, as shown in FIGS. 4a and 4b, each auxiliary lens 20 may have shape and size such that it covers only an upper or lower portion of the main lens 14.

Furthermore, in the present invention, the main lenses and the auxiliary lenses 20 are embodied such that alignment marks 30 are formed on the main lenses 14 and the auxiliary lenses 20 to facilitate alignment of the auxiliary lenses 20 with the main lenses 14 during the auxiliary lens attachment process.

The alignment marks 30 may be formed of semitransparent points which are formed on the perimeter of each of the main lenses 14 and the auxiliary lenses 20. In this case, when attaching the auxiliary lenses 20 to the main lenses 14 of the main eyeglass body 10 using magnetic force, the user can easily align the lenses 14 and 20 with each other.

For instance, multifocal lenses which are used to compensate for presbyopia may be employed as the auxiliary lenses 20. Alternatively, lenses for protecting the eyes from harmful rays may be used as the auxiliary lenses 20.

In the drawings, reference numeral 13 denotes a wire, and reference numeral 16 denotes eyeglass temples.

In embodiments of the present invention, two auxiliary lenses 20, including upper and lower half lenses illustrated in FIGS. 4a and 4b, may be attached together to each main lens 14, as needed. Alternatively, an additional auxiliary lens having another function may be attached to each auxiliary lens 20 illustrated in FIG. 3. To embody such a double auxiliary lens structure, transparent magnetic films must also be applied to front surfaces of the respective auxiliary lenses 20, which are attached to the main lenses 14 by magnetic force.

While various embodiments have been described above, it will be understood to those skilled in the art that the embodiments described are by way of example only. Accordingly, the disclosure described herein should not be limited based on the described embodiments.

1. Glasses having detachable auxiliary lenses, wherein a transparent magnetic film (14) is applied to a front surface of each of main lenses (14) of a main eyeglass body (10), and a transparent magnetic film (22) is applied to a rear surface of each of the auxiliary lenses (20) that are detachably attached to the respective main lenses (14).

2. The glasses of claim 1, wherein each of the transparent magnetic films (14) and (22) of the main lenses (14) and the auxiliary lenses (20) comprises a cobalt-added titanium dioxide film and is provided along a perimeter of the corresponding lens (14), (20).

3. The glasses of claim 1, wherein an alignment mark (30) is formed on each of the main lenses (14) and the auxiliary lenses (20) so that alignment of the auxiliary lenses (20) with the respective main lenses (14) is facilitated when the auxiliary lenses (20) are attached to the corresponding main lenses (14).
